(19) United States
(12) Patent Application Publication
(10) Pub. No.: US 2013/0258944 A1
(43) Pub. Date: Oct. 3, 2013

(54) Method for configuring a home node with a secure address for an operator network node

(71) Applicant: QUALCOMM INCORPORATED, San Diego, CA (US)

(72) Inventor: Anand PALANIGOUNDER, San Diego, CA (US)

(73) Assignee: QUALCOMM Incorporated, San Diego, CA (US)

(21) Appl. No.: 13/652,318

(22) Filed: Oct. 15, 2012

Related U.S. Application Data
(60) Provisional application No. 61/616,886, filed on Mar. 28, 2012.

(51) Int. Cl. H04W 8/26

(52) U.S. Cl. 370/328

(57) ABSTRACT

Disclosed is a method for configuring a home node with a secure address for an operator network node. In the method, the home node receives, from a removable smartcard, an initial address for an initial serving network node. The home node establishes communication with the initial serving network node using the initial address. The home node receives the secure address from the initial serving network node. The home node communicates with the operator network node using the secure address.

### CROSS-REFERENCE TO RELATED APPLICATION

This application claims the benefit of U.S. Provisional Application No. 61/616,886, filed Mar. 28, 2012, which application is incorporated herein by reference.

### BACKGROUND

1. Field

The present invention relates generally to configuring a home node with operator specific information.

2. Background

A home evolved nodeB (H(e)NB), such as a Long-Term Evolution (LTE) femtocell, is deployed by a network operator to expand and increase network capacity. The H(e)NB is a class of small cells, which may be placed in a home or small business or even outdoor environments, and which may use an internet connection to provide coverage indoors or outdoors. Because the H(e)NB typically uses the broadband internet connection of the home or enterprise, it is considered a cost effective alternative to expanding the coverage and capabilities of an operator's macro cellular network.

To reduce device cost and to enable widespread adoption, it may be desirable for an operator to allow use of a generic open-market H(e)NB, instead of a device customized to a specific operator network, to take advantage of increased economy of scale and ease of deployment. However, network operators generally do not want to expose sensitive network information to a third party or attacker during the configuration of the H(e)NB.

There is therefore a need for a technique for configuring a home node with operator specific information in a manner that does not expose the information to an untrusted third party.

### SUMMARY

An aspect of the present invention may reside in a method for configuring a home node with a secure address for an operator network node. In the method, the home node receives, from a removable smartcard, an initial address for an initial serving network node. The home node establishes a communication with the initial serving network node using the initial address. The home node receives the secure address from the initial serving network node. The home node communicates with the operator network node using the secure address.

In more detailed aspects of the invention, the home node may receive the initial address from a hosting party SIM application on the removable smartcard. The home node may communicate with the initial serving network node over an insecure link using a secure protocol. The home node may comprise a Home NodeB, a Home eNodeB, an open market Home eNodeB, a small cell, or a femtocell.

In other more detailed aspects of the invention, the operator network node may comprise a home node management system, a security gateway, or a home node gateway.

Another aspect of the invention may reside in a home node which may include: means for receiving, from a removable smartcard, an initial address for an initial serving network node; means for establishing communication with the initial serving network node using the initial address; means for receiving a secure address from the initial serving network node; and means for communicating with an operator network node using the secure address.

Another aspect of the invention may reside in a remote station which may include a processor configured to: receive, from a removable smartcard, an initial address for an initial serving network node; establish communication with the initial serving network node using the initial address; receive a secure address from the initial serving network node; and communicate with an operator network node using the secure address.

Another aspect of the invention may reside in a computer program product, comprising computer-readable medium, comprising code for causing a computer to receive, from a removable smartcard, an initial address for an initial serving network node; code for causing a computer to establish communication with the initial serving network node using the initial address; code for causing a computer to receive a secure address from the initial serving network node; and code for causing a computer to communicate with an operator network node using the secure address.

An aspect of the present invention also may reside in a method for configuring a home node with a secure address for an operator network node. In the method, the home node receives an initial address for an initial serving network node from a field-programmed removable device. The home node establishes a communication with the initial serving network node using the initial address. The home node receives the secure address from the initial serving network node. The home node communicates with the operator network node using the secure address.

In more detailed aspects of the invention, the field-programmed removable device may be a removable smartcard, and the home node may receive the initial address from a hosting party SIM application on the removable smartcard. The hosting party may program the field-programmed removable device with the initial address after delivery of the field-programmed removable device to the hosting party. The home node may communicate with the initial serving network node over an insecure link using a secure protocol. The home node may comprise an open market Home eNodeB.

Another aspect of the invention may reside in a home node which may include:

means for receiving an initial address for an initial serving network node from a field-programmed removable device; means for establishing communication with the initial serving network node using the initial address; means for receiving a secure address from the initial serving network node; and means for communicating with an operator network node using the secure address.

Another aspect of the invention may reside in a remote station which may include a processor configured to: receive an initial address for an initial serving network node from a field-programmed removable device; establish communication with the initial serving network node using the initial address; receive a secure address from the initial serving network node; and communicate with an operator network node using the secure address.

Another aspect of the invention may reside in a computer program product, comprising computer-readable medium, comprising code for causing a computer to receive an initial address for an initial serving network node from a field-programmed removable device; code for causing a computer to establish communication with the initial serving network node using the initial address; code for causing a computer to receive a secure address from the initial serving network node; and code for causing a computer to communicate with an operator network node using the secure address.

### BRIEF DESCRIPTION OF THE DRAWINGS

FIG. 1 is a block diagram of an example of a wireless communication system.

FIG. 2 is a block diagram of an example of a wireless communication system in accordance with a system architecture of H(e)NB.

FIG. 3 is a block diagram of another example of a wireless communication system in accordance with a system architecture of H(e)NB.

FIG. 4 is a flow diagram of a method for configuring a home node with a secure address for an operator network node, according to the present invention.

FIG. 5 is a block diagram of a computer including a processor and a memory.

FIG. 6 is a flow diagram of another method for configuring a home node with a secure address for an operator network node, according to the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

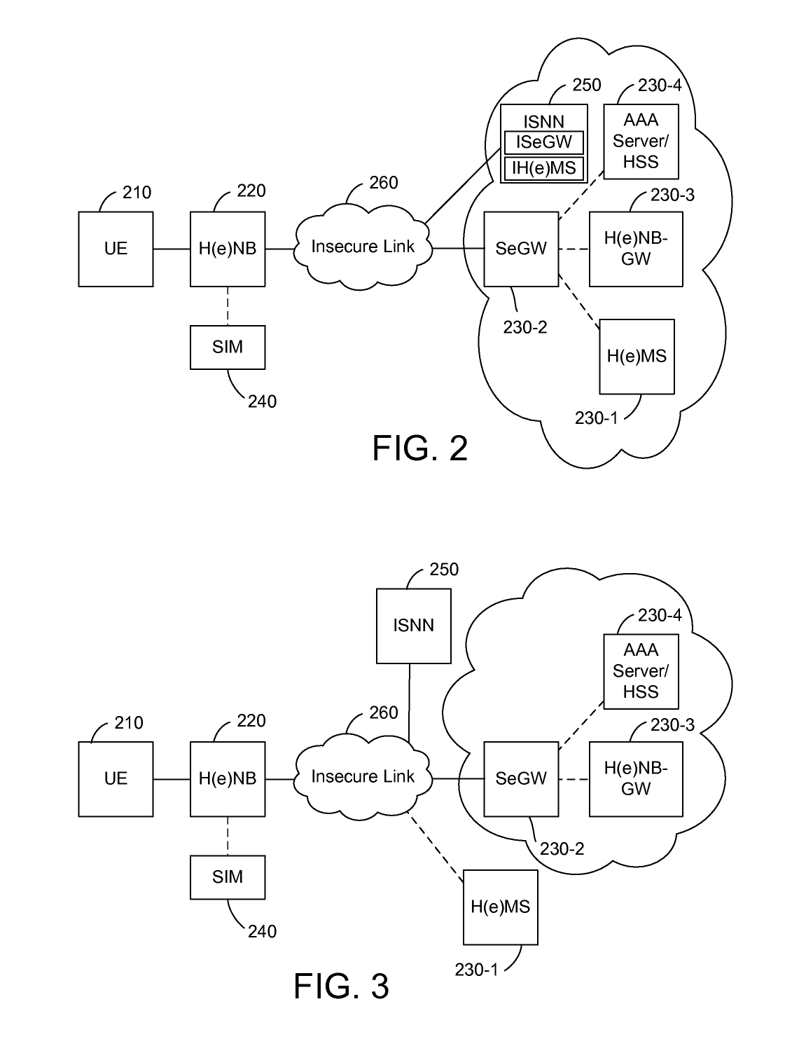

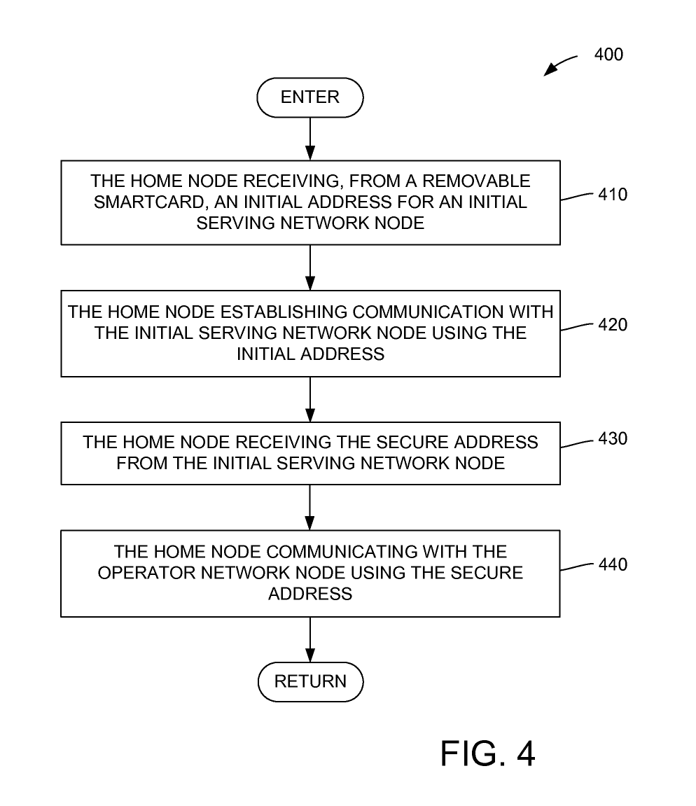

With reference to FIGS. 2 through 5, an aspect of the present invention may reside in a method 400 for configuring a home node 220 with a secure address for an operator network node 230-N. In the method, the home node receives, from a removable smartcard 240, an initial address for an initial serving network node (ISNN) 250 (step 410). The home node establishes communication with the initial serving network node using the initial address (step 420). The home node receives the secure address from the initial serving network node (step 430). The home node communicates with the operator network node using the secure address (step 440).

The home node 220 may receive the initial address from a hosting party SIM (Subscription Identity Module) application on the removable smartcard 240. The home node may communicate with the initial serving network node 250 over an insecure link 260, such as the internet, using a secure protocol, such as IPsec or Transport Layer Security (TLS). The home node may comprise a Home NodeB, a Home eNodeB, an open market Home eNodeB, or a small cell. The operator network node 230-N may comprise a home node management system (H(e)MS) 230-1, a security gateway system (SeGW) 230-2, or a home node gateway (H(e)NB-GW 230-3. The system operator network may also include an AAA server/HSS 230-4. The secure address may be a secret address.

The home node 220 may comprise a computer 500 that includes a processor 510, a storage medium 520 such as memory, a display or status lights 530, and an input 540, and internet connection 550, and a wireless connection 560 for communicating with a user equipment (UE) 210.

Another aspect of the invention may reside in a home node 220/500 which may include: means 510 for receiving, from a removable smartcard 240, an initial address for an initial serving network node 250; means 810 for establishing communication with the initial serving network node using the initial address; means 510 for receiving a secure address from the initial serving network node; and means 510 for communicating with an operator network node 230-N using the secure address.

Another aspect of the invention may reside in a home node 220/500 which may include a processor 510 configured to: receive, from a removable smartcard 240, an initial address for an initial serving network node 250; establish communication with the initial serving network node using the initial address; receive a secure address from the initial serving network node; and communicate with an operator network node 230-N using the secure address.

Another aspect of the invention may reside in a computer program product, comprising computer-readable medium 520, comprising code for causing a computer 500 to receive, from a removable smartcard 240, an initial address for an initial serving network node 250; code for causing a computer 500 to establish communication with the initial serving network node using the initial address; code for causing a computer 500 to receive a secure address from the initial serving network node; and code for causing a computer 500 to communicate with an operator network node 230-N using the secure address.

Accordingly, operators with operations in multiple countries may procure H(e)NBs centrally, and may distribute them for deployment in different countries where they operate networks, without being configured until deployed. For each country, the H(e)NBs may connect to a local security gateway/management system for various security and operational reasons. (See TS 33.320 for more details on the H(e)NB security architecture.)

A solution for configuring open market H(e)NBs under consideration in 3GPP uses a hosting-party SIM (HPSIM) that stores the Serving SeGW, Serving H(e)MS, and Serving H(e)NB GW addresses directly on the HPSIM. The HPSIM may be an H(e)NB specific application on a removable UICC smartcard (aka Hosting Party Module or HPM, e.g., see 3GPP TS 31.104 [C6-110602]). Note that these operator Network Node addresses may be either IPv4/v6 addresses or FQDN (Fully Qualified Domain Name).

However, the interface between the HPSIM (UICC) and the H(e)NB is not protected since there is no integrity / confidentiality protection. This gives rise to the following security problems: an attacker can modify the Serving SeGW, H(e)MS, and H(e)NB-GW address over the HPSIM—H(e)NB interface, thereby tricking the H(e)NB to connect to a network under the attacker's control; the Serving Network Node addresses (such as Serving H(e)MS / H(e)NB-GW addresses) are typically considered operator proprietary information and should not be revealed to 3rd party (“network hiding” requirement); and a 3rd party can read this information over the HPSIM—H(e)NB interface, thereby revealing network confidential info to 3rd parties/attackers.

In the present invention, only the initial SeGW, initial H(e)MS, and/or initial HeMS addresses are stored on the HPSIM. At initial power-up, the H(e)NB reads the Initial SeGW and/or H(e)MS addresses. The H(e)NB 220 establishes a connection to the initial H(e)MS 250 (FIG. 3). If the initial H(e)MS is not public, the H(e)NB establishes a secure tunnel with an initial SeGW, and then connects to the initial H(e)MS (FIG. 2). The initial H(e)MS securely configures the H(e)NB (e.g., on the secure environment or trusted environment of the H(e)NB) with the serving SeGW 230-2, the serving H(e)MS 230-1, and the Serving H(e)NB-GW 230-3 address information (collectively known as serving network nodes)). At subsequent power-ups, the H(e)NB directly connects to the serving network nodes. The serving H(e)MS and/or H(e)NB-GW addresses may not be modified by attackers because they are not also exposed to 3rd parties, since they may be sent until after an IPsec tunnel with the SeGW is established.

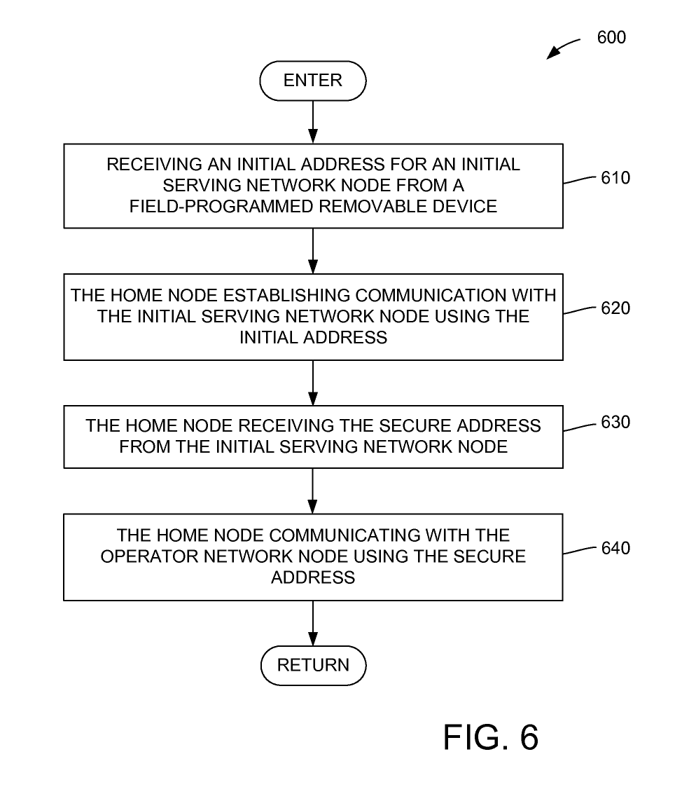

With reference to FIGS. 2-3 and 5-6, another aspect of the present invention may reside in a method 600 for configuring a home node 220 with a secure address for an operator network node 230-N. In the method, the home node receives an initial address for an initial serving network node (ISNN) 250 from a field-programmed removable device 240 (step 610). The home node establishes communication with the initial serving network node using the initial address (step 620). The home node receives the secure address from the initial serving network node (step 630). The home node communicates with the operator network node using the secure address (step 640).

The field-programmed removable device 240 may be a removable smartcard, and the home node 220 may receive the initial address from a hosting party SIM application on the removable smartcard. The hosting party may program the field-programmed removable device with the initial address after delivery of the field-programmed removable device to the hosting party.

For example, the hosting party (i.e., a consumer and/or subscriber) may use a USB (Universal Serial Bus) connection to couple a removable smartcard 240 to a desktop or laptop computer. The hosting party may upload the initial address of the initial serving network node to the removable smartcard using the computer, thus field programming the removable smartcard with the initial address. Field programming means programming not performed by the manufacturer of the home node 220. For example, a hosting party (i.e., a user) programming the removable smartcard with the initial address in the field (i.e., at the location of use) would comprise field programming. Any field programming method supported by the field programming device may be used.

The home node may communicate with the initial serving network node 250 over an insecure link 260, such as the internet, using a secure protocol, such as IPsec or Transport Layer Security (TLS) as specified in 3GPP TS 33.320 or 3GPP2 S.S0132. The home node may comprise a Home NodeB, a Home eNodeB, an open market Home eNodeB, a femtocell access point, or a small cell. The secure address may be a secret address and is not known to the hosting party or any other 3^{rd} party from whom the operator wants to keep the secure address secret. The secure address may be securely stored in the H(e)NB, such as in the Trusted Environment or the Secure Environment of the H(e)NB, for subsequent communication with an operator network node.

Another aspect of the invention may reside in a home node 220/500 which may include: means 510 for receiving an initial address for an initial serving network node 250 from a field-programmed removable device 240; means 810 for establishing communication with the initial serving network node using the initial address; means 510 for receiving a secure address from the initial serving network node; and means 510 for communicating with an operator network node 230-N using the secure address.

Another aspect of the invention may reside in a home node 220/500 which may include a processor 510 configured to: receive an initial address for an initial serving network node 250 from a field-programmed removable device 240; establish communication with the initial serving network node using the initial address; receive a secure address from the initial serving network node; and communicate with an operator network node 230-N using the secure address.

Another aspect of the invention may reside in a computer program product, comprising computer-readable medium 520, comprising code for causing a computer 500 to receive an initial address for an initial serving network node 250 from a field-programmed removable device 240; code for causing a computer 500 to establish communication with the initial serving network node using the initial address; code for causing a computer 500 to receive a secure address from the initial serving network node; and code for causing a computer 500 to communicate with an operator network node 230-N using the secure address.

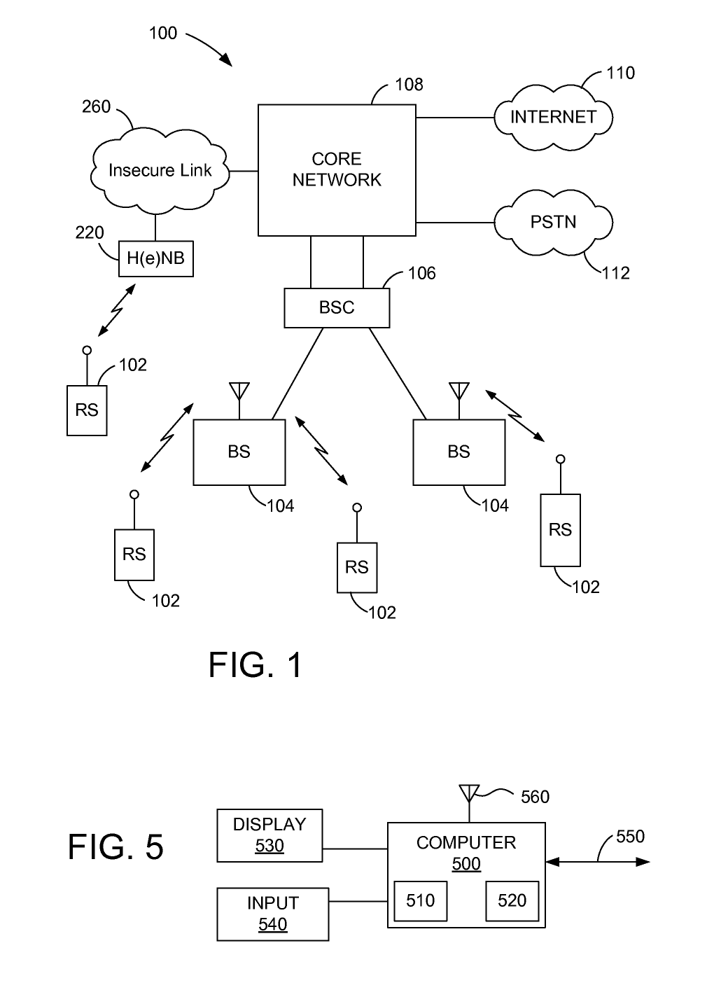

With reference to FIG. 1, a wireless remote station (RS) 102 (e.g. UE 210) may communicate with one or more base stations (BS) 104 of a wireless communication system 100, or through a H(e)NB 220. The wireless communication system 100 may further include one or more base station controllers (BSC) 106, and a core network 108. Core network may be connected to an Internet 110 and a Public Switched Telephone Network (PSTN) 112 via suitable backhauls. A typical wireless mobile station may include a handheld phone, or a laptop computer. The wireless communication system 100 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for configuring a home node with a secure address for an operator network node, comprising:
the home node receiving, from a removable smartcard, an initial address for an initial serving network node;
the home node establishing communication with the initial serving network node using the initial address;
the home node receiving the secure address from the initial serving network node; and
the home node communicating with the operator network node using the secure address.

2. A method for configuring a home node as defined in claim 1, further comprising:
the home node receiving the initial address from a hosting party SIM application on the removable smartcard.

3. A method for configuring a home node as defined in claim 1, wherein the home node communicates with the initial serving network node over an insecure link using a secure protocol.

4. A method for configuring a home node as defined in claim 1, wherein the operator network node comprises a home node management system, a security gateway, or a home node gateway.

5. A method for configuring a home node as defined in claim 1, wherein the home node comprises a Home NodeB or a Home eNodeB.

6. A method for configuring a home node as defined in claim 1, wherein the home node comprises an open market Home eNodeB.

7. A method for configuring a home node as defined in claim 1, wherein the home node comprises a small cell.

8. A home node, comprising:
means for receiving, from a removable smartcard, an initial address for an initial serving network node;
means for establishing communication with the initial serving network node using the initial address;
means for receiving a secure address from the initial serving network node; and
means for communicating with an operator network node using the secure address.

9. A home node as defined in claim 8, further comprising:
means for receiving the initial address from a hosting party SIM application on the removable smartcard.

10. A home node as defined in claim 8, wherein the home node communicates with the initial serving network node over an insecure link using a secure protocol.

11. A home node as defined in claim 8, wherein the operator network node comprises a home node management system, a security gateway, or a home node gateway.

12. A home node as defined in claim 8, wherein the home node comprises a Home NodeB or a Home eNodeB.

13. A home node as defined in claim 8, wherein the home node comprises an open market Home eNodeB.

14. A home node as defined in claim 8, wherein the home node comprises a small cell.

15. A home node, comprising:
a processor configured to:
receive, from a removable smartcard, an initial address for an initial serving network node;
establish communication with the initial serving network node using the initial address;
receive a secure address from the initial serving network node; and
communicate with an operator network node using the secure address.

16. A home node as defined in claim 15, wherein the processor is further configured to:
receive the initial address from a hosting party SIM application on the removable smartcard.

17. A home node as defined in claim 15, wherein the home node communicates with the initial serving network node over an insecure link using a secure protocol.

18. A home node as defined in claim 15, wherein the operator network node comprises a home node management system, a security gateway, or a home node gateway.

19. A home node as defined in claim 15, wherein the home node comprises a Home NodeB or a Home eNodeB.

20. A home node as defined in claim 15, wherein the home node comprises an open market Home eNodeB.

21. A home node as defined in claim 15, wherein the home node comprises a small cell.

22. A computer program product, comprising:
computer-readable medium, comprising:
code for causing a computer to receive, from a removable smartcard, an initial address for an initial serving network node;
code for causing a computer to establish communication with the initial serving network node using the initial address;
code for causing a computer to receive a secure address from the initial serving network node; and
code for causing a computer to communicate with an operator network node using the secure address.

23. A computer program product as defined in claim 22, wherein the computer-readable storage medium further comprises:
code for causing a computer to receive the initial address from a hosting party SIM application on the removable smartcard.

24. A computer program product as defined in claim 22, wherein the home node communicates with the initial serving network node over an insecure link using a secure protocol.

25. A computer program product as defined in claim 22, wherein the operator network node comprises a home node management system, a security gateway, or a home node gateway.

26. A computer program product as defined in claim 22, wherein the home node comprises a Home NodeB or a Home eNodeB.

27. A computer program product as defined in claim 22, wherein the home node comprises an open market Home eNodeB.

28. A computer program product as defined in claim 22, wherein the home node comprises a small cell.

29. A method for configuring a home node with a secure address for an operator network node, comprising:
the home node receiving an initial address for an initial serving network node from a field-programmed removable device;
the home node establishing communication with the initial serving network node using the initial address;
the home node receiving the secure address from the initial serving network node; and
the home node communicating with the operator network node using the secure address.

30. A method for configuring a home node as defined in claim 29, wherein:
the field-programmed removable device is a removable smartcard;
the home node receives the initial address from a hosting party SIM application on the removable smartcard.

31. A method for configuring a home node as defined in claim 29, wherein a hosting party programs the field-programmed removable device with the initial address after delivery of the field-programmed removable device to the hosting party.

32. A method for configuring a home node as defined in claim 29, wherein the home node communicates with the initial serving network node over an insecure link using a secure protocol.

33. A method for configuring a home node as defined in claim 29, wherein the home node comprises an open market Home eNodeB.

34. A home node, comprising:
means for receiving an initial address for an initial serving network node from a field-programmed removable device;
means for establishing communication with the initial serving network node using the initial address;
means for receiving a secure address from the initial serving network node; and
means for communicating with an operator network node using the secure address.

35. A home node as defined in claim 34, wherein:
the field-programmed removable device is a removable smartcard;
the means for receiving an initial address from a hosting party SIM application on the removable smartcard.

36. A home node as defined in claim 34, wherein a hosting party programs the field-programmed removable device with the initial address after delivery of the field-programmed removable device to the hosting party.

37. A home node as defined in claim 34, wherein the home node communicates with the initial serving network node over an insecure link using a secure protocol.

38. A home node as defined in claim 34, wherein the home node comprises an open market Home eNodeB.

39. A home node, comprising:
a processor configured to:
receive an initial address for an initial serving network node from a field-programmed removable device;
establish communication with the initial serving network node using the initial address;
receive a secure address from the initial serving network node; and
communicate with an operator network node using the secure address.

40. A home node as defined in claim 39, wherein:
the field-programmed removable device is a removable smartcard; and
the processor is further configured to receive the initial address from a hosting party SIM application on the removable smartcard.

41. A home node as defined in claim 39, wherein a hosting party programs the field-programmed removable device with the initial address after delivery of the field-programmed removable device to the hosting party.

42. A home node as defined in claim 39, wherein the home node communicates with the initial serving network node over an insecure link using a secure protocol.

43. A home node as defined in claim 39, wherein the home node comprises an open market Home eNodeB.

44. A computer program product, comprising:
computer-readable medium, comprising:
code for causing a computer to receive an initial address for an initial serving network node from a field-programmed removable device;
code for causing a computer to establish communication with the initial serving network node using the initial address;
code for causing a computer to receive a secure address from the initial serving network node; and
code for causing a computer to communicate with an operator network node using the secure address.

45. A computer program product as defined in claim 44, wherein:
the field-programmed removable device is a removable smartcard; and
the computer-readable storage medium further comprises:
code for causing a computer to receive the initial address from a hosting party SIM application on the removable smartcard.

46. A computer program product as defined in claim 44, wherein a hosting party programs the field-programmed removable device with the initial address after delivery of the field-programmed removable device to the hosting party.

47. A computer program product as defined in claim 44, wherein the home node communicates with the initial serving network node over an insecure link using a secure protocol.

48. A computer program product as defined in claim 44, wherein the home node comprises an open market Home eNodeB.
